(19) United States
(12) Patent Application Publication
(10) Pub. No.: US 2026/0228830 A1
(43) Pub. Date: Aug. 6, 2026

(54) SYSTEM AND METHOD FOR INCORPORATING A MORTALITY RISK IN A FINANCIAL INSTRUMENT

(71) Applicants: Dario Fusato, Chicago, IL (US); Tony Derossi, Boulder, CO (US)

(72) Inventors: Dario Fusato, Chicago, IL (US); Tony Derossi, Boulder, CO (US)

(21) Appl. No.: 19/453,823

(22) Filed: Jan. 20, 2026

Related U.S. Application Data
(63) Continuation-in-part of application No. 18/338,515, filed on Jun. 21, 2023, now abandoned.
(60) Provisional application No. 63/354,003, filed on Jun. 21, 2022.

(51) Int. Cl. G06Q 40/06

(52) U.S. Cl. CPC G06Q 40/068; G06Q 2220/00

(57) ABSTRACT

A computer method and system for processing data for a constituency of investment pool members wherein each member is a participant to an investment transaction product that is in-part dependent upon other member's investment transaction products. Initial user inputs are received for defining an investment transaction product for a user in the constituency of pool members, comprising at least an initial funding amount and one prescribed user payout age. Electronic documentation is associated with the user investment transaction product which can provide encrypted security for the user investment transaction. Upon determination of a death a portion of a pool member's funds, determined to have deceased prior to their prescribed user payout age, is reallocated to investment funds associated with surviving pool members. A determined payout distribution is provided to a pool member upon the occurrence of a pool member reaching their prescribed user payout age.

### CROSS-REFERENCE TO RELATED APPLICATION(S)

This application is a Continuation-in-Part of co-pending U.S. patent application Ser. No. 18/338,515, filed Jun. 21, 2023 by Dario Fusato and Tony DeRossi which claims the benefit of priority under 35 U.S.C. § 119 to prior filed U.S. Provisional Patent Application No. 63/354,003, filed Jun. 21, 2022 by Dario Fusato and Tony Derossi, the complete contents of each of which are hereby incorporated herein by reference.

### BACKGROUND

### Technical Field

The disclosed embodiments generally relate to financial management systems and, more particularly, to a method and computing system for effecting a financial investment transaction, providing a longevity credit for pool members participating in the financial investment transaction.

### Background

Retirement planning is a complicated exercise because the future is uncertain. Nonetheless, prior art retirement calculators often employ deterministic models that output seemingly precise predicted value of a portfolio. Typically, a user is required to input a number of parameters such, for example, as a fixed rate of inflation, a fixed rate of return, and a specified retirement age. Using these user-input values, the prior art calculators compute a future value of the portfolio at the specified retirement age or at some other specified point in time. This computed portfolio value, however, is of limited use to an investor, or may even be misleading to the investor, because the chance of achieving the computed value is strongly dependent upon assumptions. As any competent investor knows, future rate of return or rate of inflation varies from month-to-month and from year-to-year, depending on a myriad of highly variable economic parameters. Moreover, one's actual life span may be shorter or longer than that published in a life expectancy table, thereby creating further uncertainties in the computed portfolio value.

Accordingly, there is a need for better financial products such as for improving the retirement planning outcome that provides increased certainty for providing financial returns upon an investor reaching a prescribed age, such as a retirement age, for achieving a retirement goal.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

Generally, the illustrated embodiments relate to a computer technological platform configured and functional to manage longevity upside (“mortality credit”) of a pooled investment. For instance, a group of investors (“the pool”) whom invest together in an index fund or EFT, which related proceedings, as well as the initial investments, are distributed among the participants that reach a pre-agreed payout age accordingly to pre-agreed fair rules. A benefit of the financial tool provided by the illustrated embodiments is effectively and securely, managing financial products providing a longevity credit while improving long term financial planning for an investor in the pool.

To achieve these and other advantages and in accordance with the purpose of the illustrated embodiments, in one aspect, described is a computer method and system for processing data for a constituency of investment pool members wherein each member is a participant to an investment transaction product that is in-part dependent upon other member's investment transaction products. Using a data processing system, initial user inputs are received for defining an investment transaction product for a user in the constituency of pool members, comprising at least: a) an initial funding amount and b) at least one prescribed user payout age. Electronic documentation is then formulated that is associated with the user investment transaction product which preferably provides encrypted security for the user investment transaction. Preferably using AI technology, the occurrence of a death is determined for one or more pool members prior to their prescribed user payout age. In some embodiments, machine-readable investment-product record(s) can be stored as a secure, encrypted data object having a system-generated, non-human-readable identifier and maintained within a structured, tamper-evident data repository. At least a portion of a pool member's funds, determined to have deceased prior to their prescribed user payout age, is reallocated to investment funds associated with other surviving pool members. A payout distribution is provided to a pool member upon the occurrence of a pool member reaching their prescribed user payout age wherein the payout includes funds associated with: 1) a value obtained from investment of the pool member's initial funding amount; and 2) a value obtained from funds reallocated to the pool member from other pool members determined to have deceased prior to their prescribed user payout age.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates an example computer/communication network utilized for the illustrated embodiments.

FIG. 2 illustrates an example network device/node utilized for providing a technological platform for implementing the illustrated embodiments in the computer/communication network of FIG. 1.

FIG. 3 illustrates certain software modules of the network device/node of FIG. 1 in accordance with the illustrated embodiments.

FIG. 4 illustrates a flowchart depicting a process for implementing a financial tool in accordance with the illustrated embodiments.

FIG. 5 illustrates an exemplary user interface provided to an investor in accordance with the illustrated embodiments.

FIG. 6 depicts an overview of the system and method for incorporating a mortality risk in a financial instrument interface with external systems.

FIG. 7A and FIG. 7B depict an overview of the determination of matrix of coefficients of the system and method for incorporating a mortality risk in a financial instrument.

FIG. 8 depicts an exemplary embodiment of the system and method for incorporating a mortality risk in a financial instrument in use.

FIG. 9A and FIG. 9B depict an exemplary embodiment of an outcome and output of the system and method for incorporating a mortality risk in a financial instrument.

FIG. 10 depicts a schematic function block diagram of an implementation of the instantiation of a new client/pool member into the system method for incorporating a mortality risk in a financial instrument.

FIG. 11 depicts a schematic function block diagram of an implementation of the system and method for incorporating a mortality risk in a financial instrument.

FIG. 12 depicts a schematic function block diagram of an implementation of the method for incorporating a mortality risk in a financial instrument.

FIG. 13 depicts a computing system adapted and configured to implement the system and method for incorporating a mortality risk in a financial instrument.

### DETAILED DESCRIPTION

Aspects of the disclosed embodiments are shown in the following description and related drawings directed to specific illustrated embodiments. Alternate preferred embodiments may be devised without departing from the scope of the illustrated embodiments. Additionally, well-known elements of the illustrated embodiments will not be described in detail or will be omitted so as not to obscure the relevant details of the illustrated embodiments.

The word “exemplary” is used herein to mean “serving as an example, instance, or illustration.” Any embodiment described herein as “exemplary” is not necessarily to be construed as preferred or advantageous over other embodiments. Likewise, the term “illustrated embodiments” does not require that all illustrated embodiments include the discussed feature, advantage or mode of operation.

The terminology used herein is for the purpose of describing particular embodiments only and is not intended to be limiting of the illustrated embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits, by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the illustrated embodiments may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described. All publications mentioned herein are incorporated herein by reference to disclose and describe the methods and/or materials in connection with which the publications are cited.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims. All publications and references cited herein are expressly incorporated herein by reference in their entirety.

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

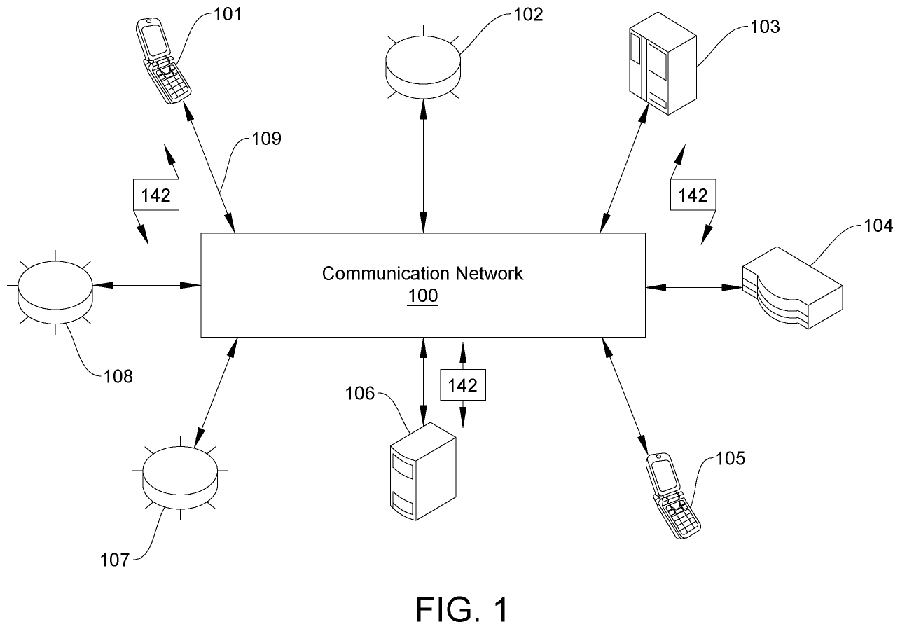

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, web servers 106, routers 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

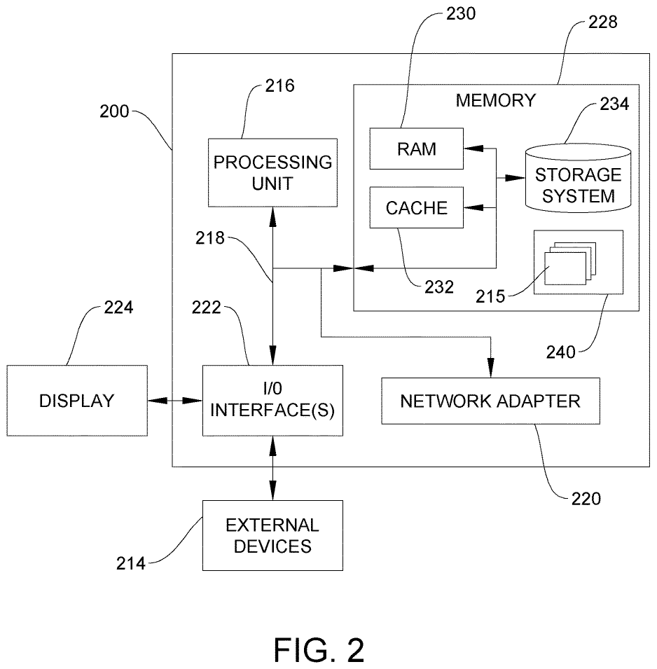

FIG. 2 is a schematic block diagram of an example network computing device 200 (e.g., client computing device 103, server 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

System/device 200 is intended to represent any type of computer system capable of carrying out the teachings of various illustrated embodiments. System 200 is only one example of a suitable system and is not intended to suggest any limitation as to the scope of use or functionality of embodiments described herein. For instance, system 200 may be configured as a cloud based computing system. Regardless, computing device/system 200 is capable of being implemented and/or performing any of the functionality set forth herein.

Computing system 200 may be operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

Computing system 200 may be described in the general context of computer system-executable instructions, such as program modules, being executed by a computer system. Generally, program modules may include routines, programs, objects, components, logic, data structures, and so on that perform particular tasks or implement particular abstract data types. Computing system 200 may be practiced in distributed data processing environments where tasks are performed by remote processing devices that are linked through a communications network. In a distributed data processing environment, program modules may be located in both local and remote computer system storage media including memory storage devices.

System 200 is shown in FIG. 2 in the form of a computing device. The components of device 200 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing system 200 typically includes a variety of computer system readable media. Such media may be any available media that is accessible by system 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 215 may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of the invention as described herein.

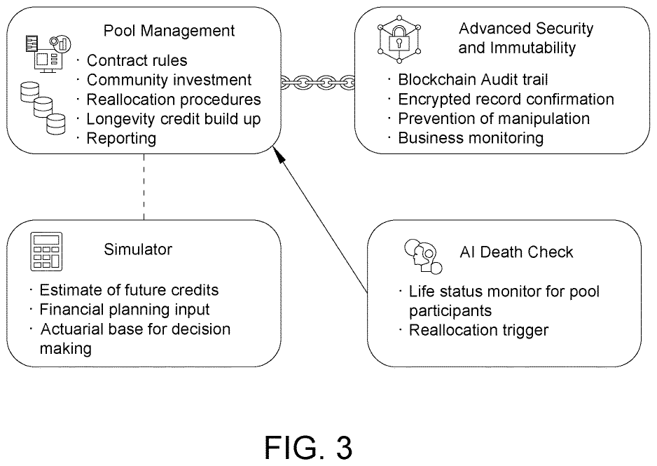

In accordance with the illustrated embodiments, and with reference to FIG. 3, program modules 215 preferably include a: 1) Management module 310; 2) Security Module 320; 3) Simulator module 330; and 4) Death check module 340.

Briefly, the Management module 310 is a software module configured and operable to manage the longevity credits accumulated within pools investing in a same portfolio of funds/ETFs. Each participant pool member is preferably characterized by his/her current age and sex at birth, a chosen payout age and a chosen initial investment. Preferably, when a participant pool member dies or leaves the pool, their shares are reallocated in a fair way amongst the surviving participants of the pool. The reallocation mechanism preferably is dependent upon the age, the actuarial death probability at that time and the initial investment amount of each one of the remaining surviving participants. A longevity credit is added to the market returns for each surviving participant that is accumulated over time, which accumulates reallocations until the designated payout age, preferably providing significant scalability of the investment pools provided by system 200.

The Security module 320 is a software module configured and operable to provide security, immutability, transparency and fairness to pool members preferably via the combined use of block chain and encryption technology. For instance, a new record relating to a transaction of a pool member (e.g., including, but not limited to: contract terms, virtual reallocation, transactions with the underlying funds/ETFs,) generates a duplicate record inserted into a block chain, thus providing an audit trail of change, which block chain is preferably stored in the cloud. Exemplary functionality of the security module 320 includes (but is not limited to): data being stored in secure fixed locations (which does not cross international borders); data being stored for necessary prolonged time periods; data of pool members being associated with audit technology so as to provide proper authentication and enabling regulatory audit controls (audit verification may be provided via an API); data being encapsulated from system users/pool members and encrypted (preferably using industry standard AES256-CBC) for improved security. Thus, “human touch” is removed from encryption with key management protocols emulating “top secret” levels whereby security data is chained. Hence, not only are transactions tracked, but also tracked are users, IP addresses, errors, execution times, API calls, record exfiltration, and additional items. Accordingly, the security module 320 in accordance with the illustrated embodiments provides a technological platform that protects against data breach and record alteration so as to mitigate cyberattack risk, provides a verified policy of record, and increases efficiency and transparency for pool members.

The death check module 340 is a software module configured and operable to provide accurate and fair application of longevity credits amongst the pool members which requires prompt knowledge of the occurrence of deaths of members within the pool. It is to be understood that official data sources for determining death occurrence are the SSDI (Social Security Death Index) and the National Death Index (NDI) maintained by the CDC. However, it is to be understood and appreciated that such database records are not sufficiently accurate nor timely (they often have a backlog of recording deaths for prolonged time periods (e.g., months)). In accordance with the illustrated embodiments, death check module 340 of system 200 includes AI (Artificial Intelligence) technology specifically configured and functional to monitor/listen to numerous publicly available data sources providing indication of a pool member's death. For instance, such data sources may include (but is not to be understood to be limited to): online newspapers, worshipping and obituaries; social media sources; local courthouses and genealogy sites. In accordance with the illustrated embodiments, the AI provided and utilized by the death module 340 of system 200 inspects and analyzes various publicly available data sources to determine content provided by each electronic data source to extract/determine data/information regarding one or more pool member's current life status (e.g., dead or alive) based upon data collected from that information, which preferably generates a death status alert in system 200 for one or more pool members determined to have deceased. In some embodiments, automated event-detection can be accomplished using pattern-matching logic or machine-assisted correlation. Preferably, the AI generated death status alert provided by the death module 340 of system 200 is cross-checked with pool member identity data stored in the platform of system 200. Further, in some embodiments, external data can be filtered, validated, and/or cross-checked, byt cross-correlating external data via a trained computational model configured to reduce false positives.

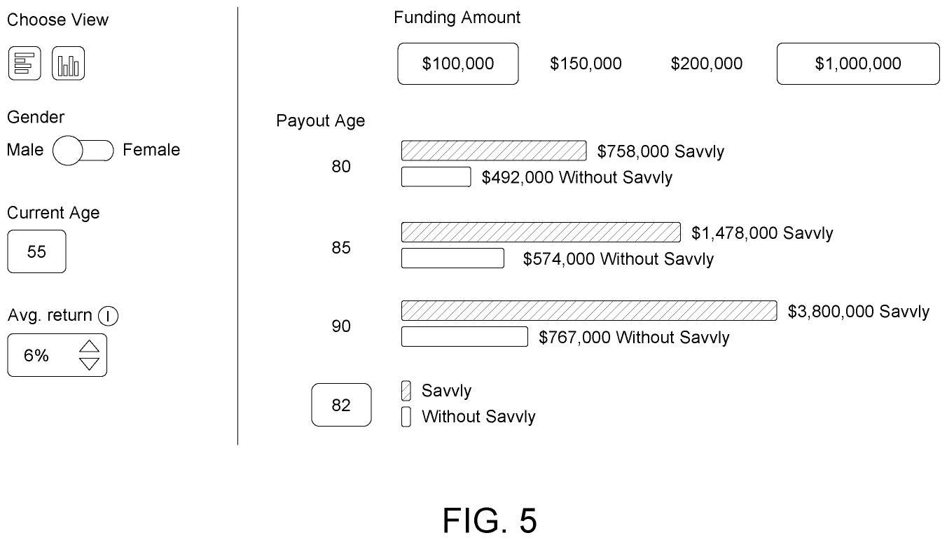

With regard to the simulator module 330 (some the functionality of which is shown in FIG. 5), it is a software module configured and operable to preferably provide an estimate of the longevity credits that will be allocated to pool members, via a graphic UI (FIG. 5 depicts the certain estimated information displayed to a user, preferably prior to subscribing to the subject financial instrument based user input data). Preferably, input to simulator module 330 is similar to that utilized to generate a position in the back end of system 200 (e.g., current age, sex at birth, investment amount) with an assumption calculation provided by system 200 providing average future market performance of the user selected funds. Additionally, actuarial mortality tables are preferably utilized to estimate the longevity credit growth over time provided to a prospective pool member. Thus, simulator software module 330 preferably includes a calculator component that utilizes an API configured to feed a web or mobile application, or to integrate with a portfolio management/financial planning tool. It is to be appreciated that the system 200 preferably tracks in real time both the market value of the common investments and of the assets from deceased pool members to surviving pool members. Hence the simulator component 330 is configured and operable to provide estimation of total investment returns at payout age and daily updates these estimates based on market performance and pool performance.

With the certain modules described above (e.g., 310-340), it is to be further appreciated that system 200 may also communicate with one or more external devices 214 such as a keyboard, a pointing device, a display 224, etc. ; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

It is to be appreciated and understood, that in accordance with the illustrated embodiments, system 200 preferably includes an Application Program Interface (API) configured for integration with the Internet and/or a user mobile device software application that provides data communication with a portfolio management and/or financial planning computer software tool (including third party financial service software) associated with system 200.

FIGS. 1 and 2 are intended to provide a brief, general description of an illustrative and/or suitable exemplary environment in which embodiments of the below described present invention may be implemented. FIGS. 1 and 2 are exemplary of a suitable environment and are not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

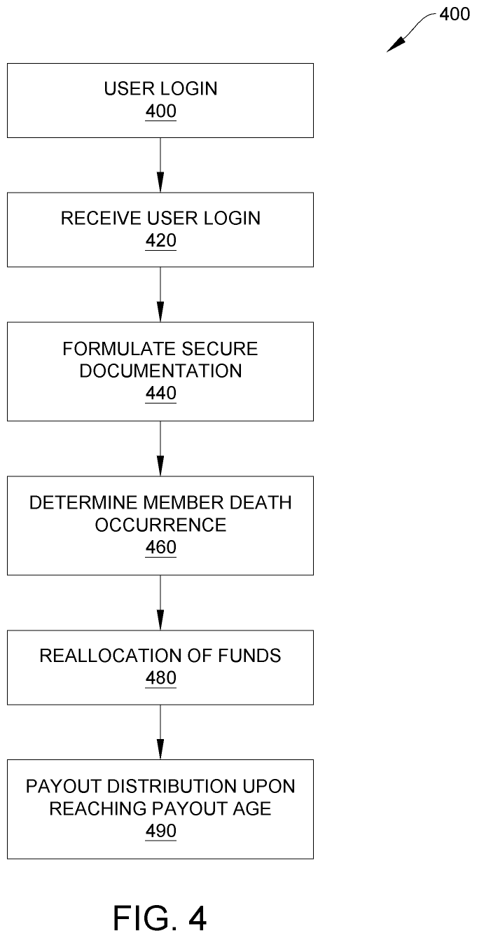

With the exemplary communication network 100 (FIG. 1) and computing device/system 200 (FIG. 2) along with certain software modules (FIG. 3) being generally shown and discussed above, description of certain illustrated embodiments of the present invention will now be provided. With reference now to FIG. 4 shown is a flow chart demonstrating implementation of the various exemplary embodiments in accordance with an exemplary process 400 for managing a financial tool providing a longevity upside (“mortality credit”) of a pooled investment, whereby a group of investors (“the pool”) collectively invest in a financial instrument (e.g., an index fund or EFT) which proceeds are distributed among the participants of the pool that reach a pre-agreed payout age accordingly to pre-agreed fair rules. As described herein in accordance with the illustrated embodiments, a benefit of the financial tool provided by process 400 is the effective and secure management of financial products providing a longevity credit while improving long term financial planning for an investor in the pool. It is noted that the order of steps shown in FIG. 4 is not required, so in principle, the various steps may be performed out of the illustrated order. Also certain steps may be skipped, different steps may be added or substituted, or selected steps or groups of steps may be performed in a separate application following the embodiments described herein.

Starting at step 410, after a user (e.g., pool member) logs into the system 200 providing the financial tool in accordance with the illustrated embodiments (preferably via authentication of user credentials), at step 420 the system 200 (preferably via management module 310) receives initial user inputs for an investment transaction product (e.g., information associated with an investment strategy (such as an index fund or EFT) for an initial funding amount, which user is a member of a constituency of pool members subscribed to the financial tool defining the investment transaction product for the pool members. For instance, such user input includes at least an initial funding amount and at least one prescribed user payout age, and also preferably the user's current age and gender identification. In accordance with the illustrated embodiments, the system 200 may be configured to permit a subscribing pool member to extend their prescribed user payout age prior to a pool member reaching their initial designated payout age (step 420)(e.g., change a payout age from 70 to 75).

Next, at step 440, the system 200 preferably formulates electronic documentation (preferably via security module 320) associated with the aforesaid user investment transaction product including security techniques for the user investment transaction. In accordance with the illustrated embodiments, the security techniques include creating an encryption hash indicator for the electronic documentation such that the electronic documentation is encapsulated from the constituency of investment pool members (and any unscrupulous users). Preferably, the encryption hash uses the Advanced Encryption Standard (AES). The encryption hash is preferably stored in a private block chain so as to provide evidence of the user's transaction wherein the private block chain creates an audit trail on the private block chain using an automatically generated encryption key for maintaining pool member's data to be immutable, auditable and transparent. For instance, preferably the block chain evidence of the user's transaction includes one or more of: contract terms; virtual reallocation of funds from other pool members, and transactions with the underlying funds/ETFs.

Once the electronic documentation is formulated (step 440), at step 460 the system 200 is uniquely configured and functional to automatically determine the occurrence of a death for one or more pool members prior to their prescribed user payout age (step 420) (preferably via death check module 340). In accordance with the illustrated embodiments, this preferably includes determining the occurrence of a death for one or more pool members by using one or more Artificial Intelligence (AI) techniques, including the use of one or more electronic data sources and/or one or more online media sources. For instance, the electronic data sources and/or one or more online media sources may include one or more: online newspapers; worshipping and obituary listings; social media websites; courthouse electronic records; and electronic genealogy data records.

In the event a pool member was determined to have deceased prior to their prescribed user payout age (step 420) at step 460, then at step 480 the process 400 for the subject financial investment tool preferably causes system 200 (preferably via management module 310) to reallocate at least a portion of the aforesaid deceased pool member's funds to investment funds associated with surviving pool members who have not yet reached their respective payout age. It is to be understood and appreciated that in accordance with the illustrated embodiments, reallocation of a pool member's assets to other pool members preferably utilizes a combination of actuarial science and risk management techniques/processes by the system 200, and it is to be further understood that the techniques/processes of system 200 accomplish such reallocation of funds in a fair and equitable distribution in view of the different ages and invested amounts relative the other pool members. Additionally, reallocating at least a portion of a pool member's funds further may preferably include distribution of a portion of the pool member's funds, determined to have deceased prior to their prescribed payout age, to prescribed heir's associated with the deceased pool member. Additionally, reallocating at least a portion of a pool member's funds, determined to have deceased prior to their prescribed user payout age, may be dependent upon the ages and investment funds associated with the other surviving pool members.

Next, at step 490, system 200 provides a payout distribution (preferably via management module 310) to a pool member upon the occurrence of a pool member reaching their prescribed user payout age (step 420) wherein the payout preferably includes funds associated with: 1) a value obtained from investment of the pool member's initial funding amount; and 2) a value obtained from funds reallocated to the pool member from other pool members determined to have deceased prior to their prescribed user payout age. The payout distribution may also associated with 3) a value obtained from funds reallocated to the pool member from other pool members who liquidated their accumulated investment funds prior to their prescribed user payout age.

Thus, in accordance with the illustrated embodiments, a payout distribution for a member preferably includes a longevity credit accumulated over time that is added to the member's market returns associated with the member's initial funding amount that cumulates reallocations from other pool members until the member's prescribed user payout age. Preferably a member may define the payout schedule and terms, such as a lump payment, distributed payment over time (which timed spaced payments my benefit from an interest bearing account and/or additional accumulated longevity credits) and/or reinvestment in another financial tool/instrument. For instance, the payout distribution may be provided in multiple payments spread apart via prescribed time periods, wherein each succeeding payout distribution is subject to further accumulation of: 1) a value obtained from investment of the pool member's initial and any subsequent funding amounts; and 2) a value obtained from funds reallocated to the pool member from other pool members determined to have deceased prior to their prescribed user payout age, wherein each succeeding spaced multiple payment is dependent upon a succeeding user prescribed payout age. For instance, a first initial payout for a member may occur at age 65, a second payout at age 68, and a third and final payout at age 75.

In accordance with the illustrated embodiments, and with reference to FIG. 5, system 200 may further be configured and functional to provide a simulation tool 500 (preferably via simulator module 330) configured and operable to estimate total investment returns for a prospective pool member's payout age, wherein the simulation tool 500 in some embodiments includes a dedicated API configured for use by a sales front end application. Additionally, the simulation tool 500 may be configured and functional to provide scheduled updates on the estimated total investment returns for a subscribing pool member based upon financial market performance and reallocation of pool members funds. In some embodiments, reallocation of pool member funds can be implemented via a programmed rules-based engine implemented in code stored in the memory.

It is to be further appreciated and understood that system 200, in accordance with the illustrated embodiments is further configured to track, in real time, the market value of common investments of pool members and reallocated pool member funds. System 200 additionally may be configured and operable to enable a pool member to liquidate their accumulated investment funds prior to their prescribed user payout age whereby a portion of the pool member's funds are distributed to the liquidating pool member and another portion of the pool member's funds are reallocated to investment funds associated with other pool members (e.g., step 480). System 200 may further be configured and operable to enable a pool member to transfer their accumulated investment funds to one or more external accounts prior to their prescribed user payout age whereby a portion of the pool member's funds are reallocated to investment funds associated with other pool members (e.g., step 480) upon transfer of the investment funds to the one or more external accounts.

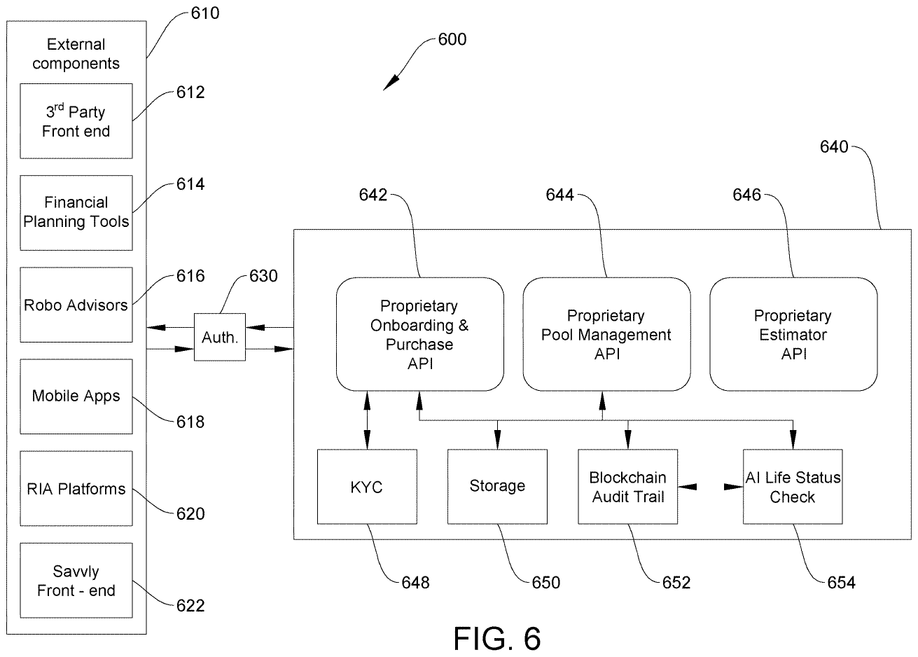

FIG. 6 depicts an overview of the system and method for incorporating a mortality risk in a financial instrument interface with external systems 600. In the embodiment depicted in FIG. 6, the system and method 600 can comprise external components 610, an authentication interface 630 and a mortality risk financial system and method 640 all in communication with each other.

In some embodiments the external components 610 can comprise various user interfaces such as a 3^{rd} party front end systems 612, financial planning tools 614, Robotic/AI Financial Advisor Systems 616, mobile applications 618, Registered Investment Advisor Platforms 620, a proprietary front-end interface 622 and/or any other known convenient and/or desired input/output/interface system.

In the embodiment depicted in FIG. 6, the mortality risk financial system and method 640 can comprise an onboarding and purchasing interface module 642, a pool management interface module 644 and an estimator module 646 which can be in communication with each other via any known, convenient and/or desired communication interface and/or method. In some embodiments, the system and method 640 can comprise a Know-Your-Customer (KYC) verification module 648 adapted and configured to identify and verify customers or systems interfacing with the mortality risk financial system and method 640. Verification module 648 can employ any known, convenient and/or desired identification and/or verification systems and/or methods. In some embodiments, the verification module 648 can be in communication with the onboarding and purchasing interface module 642 and in some alternate embodiments can be in communication with any other module and/or component of the mortality risk financial system and method 640.

In the embodiment depicted in FIG. 6, the onboarding and purchase module 642 can collect any known, convenient and/or desired client information such as, but not limited to, identifying information, contact information, age, gender, race, residence, occupation, socio-economic status, smoking information, health information and/or any other known, convenient and/or desired information. Such information can be stored in the storage module 650. The storage module 650 can configure and store such information in any known, convenient and/or desired form, format and/or media/medium. In some embodiments, information can be encrypted and/or stored in a distributed manner to enhance security. Moreover, in some embodiments, the payout distribution can be executed via an authenticated, encrypted transaction protocol in electronic communication with at least one external financial system. Additionally, the mortality risk financial system and method 640 can further comprise a blockchain audit module 652 which can be in communication with any/each of the other modules of the mortality risk financial system and method 640 such that new transactions and/or data stored within the system is interconnected with prior entries to enhance security.

As depicted in FIG. 6, the mortality risk financial system and method 640 can comprise an artificial intelligence (AI) life status check module 654, adapted in communication with other modules of the mortality risk financial system and method 640 and connected with one or more external data sources such that the AI life status check module 654 can monitor the living/deceased status of clients. In some embodiments, the AI life status check module 654 can conduct periodic analyses of the associated data sources, but in alternate embodiments the AI life status check module 654 can respond to trigger events in one or more of the external data sources and/or in still further alternate embodiments, the AI life status check module 654 can both triggered both periodically and by triggering events in one or more of the external data sources.

In operation, a user can interact with any one or more of the external components 610 and information can be presented on or provided to such one or more external components 610 and delivered to/from the mortality risk financial system and method 640 via the authentication interface 630. In some embodiments the authentication interface 630 can verify data prior to transmission to from the external components 610 and/or the mortality risk financial system and method 640. Additionally, in some embodiments the authentication interface 630 can configure data for transmission and/or use to/by the external components 610 and/or the mortality risk financial system and method 640. Upon receipt of information by the mortality risk financial system and method 640 the onboarding and purchase module 642 interact with the verification module 648 to ensure integrity and security of the mortality risk financial system and method 640 and that access to the mortality risk financial system and method 640 is authorized. The onboarding and purchase module 642 can then instantiate a financial transaction associated with a client and interact with the storage module 650 and blockchain module 652 to store and ensure integrity of such transaction and update the information in the pool management module 644. A estimator module can then receive information regarding pool members, investments and actuarial information from the AI life status check module 654 and predict, determine and/or update a payment structure to pool members. The mortality risk financial system and method 640 can then update the payment structure to pool members based on financial performance of the pool assets, information received regarding new clients/pool members and information received from the AI life status check module 654.

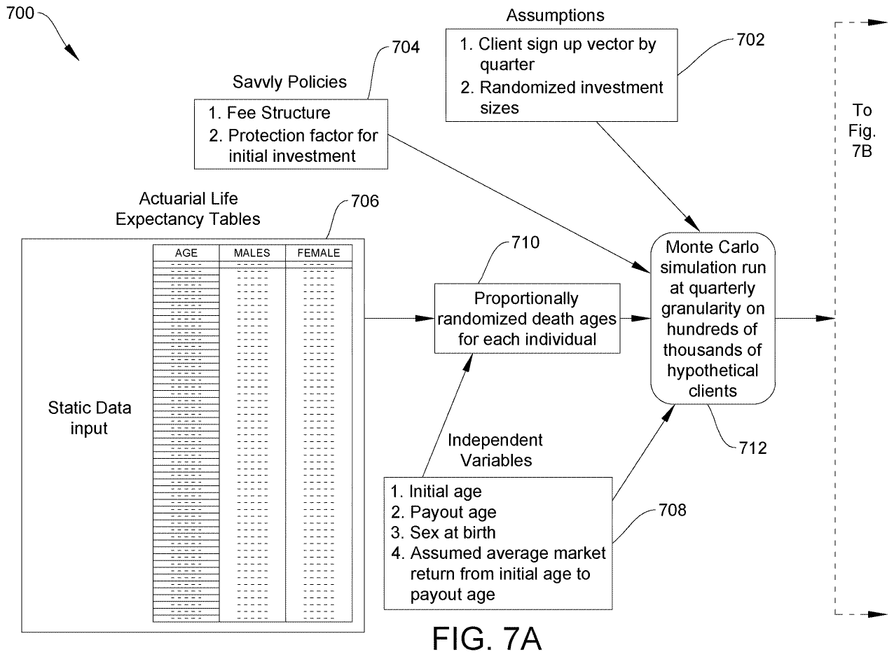

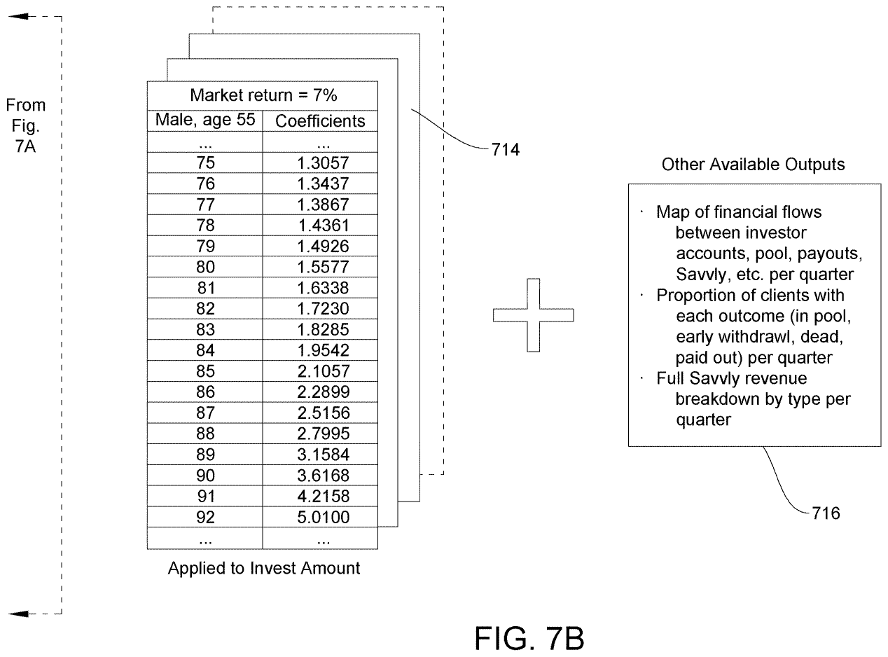

FIG. 7A and FIG. 7B depict an overview of the determination of matrix of coefficients of the system and method for incorporating a mortality risk in a financial instrument 700. In the embodiment depicted in FIGS. 7A and 7B, the determination of matrix of coefficients of the system and method for incorporating a mortality risk in a financial instrument 700 comprises performing a Monte Carlo simulation 702 based on various inputs which can comprise a fee structure 704, actuarial life expectancy tables 706, personal independent variables for each client/pool member 708 and various assumptions regarding client/pool member changes and investment performance 710.

In operation, information from the actuarial life expectancy tables 706, personal independent variables for each client/pool member 708 can be combined to estimate proportionally randomized death ages for individual pool member/clients 712. Such proportionally randomized death ages for individual pool member/clients 712 can be used in combination with various inputs which can comprise a fee structure 704, personal independent variables for each client/pool member 708 and various assumptions regarding client/pool member changes and investment performance 710 to run a Monte Carlo simulation and determine a plurality of investment coefficient tables 714 based on the input variables which can be used to predict performance and disbursements. Such variable coefficient tables can then, in some embodiments, be modified in step 716 to determine modified investment coefficients for use in determining individual client/pool member disbursements and/or provide additional output information, such as, but not limited to, client/pool member financial flow projections, anticipated changes to financial flows and/or client/pool membership and/or overall projected financial performance. Such information can be passed to and utilized by the mortality risk financial system and method 640 shown and described in relation to FIG. 6. In some embodiments, a rules-based engine can be adapted and/or configured to apply actuarial weighting and risk distribution parameters, using data such as age, longevity factor, and investment-value data stored in a secure data object structure.

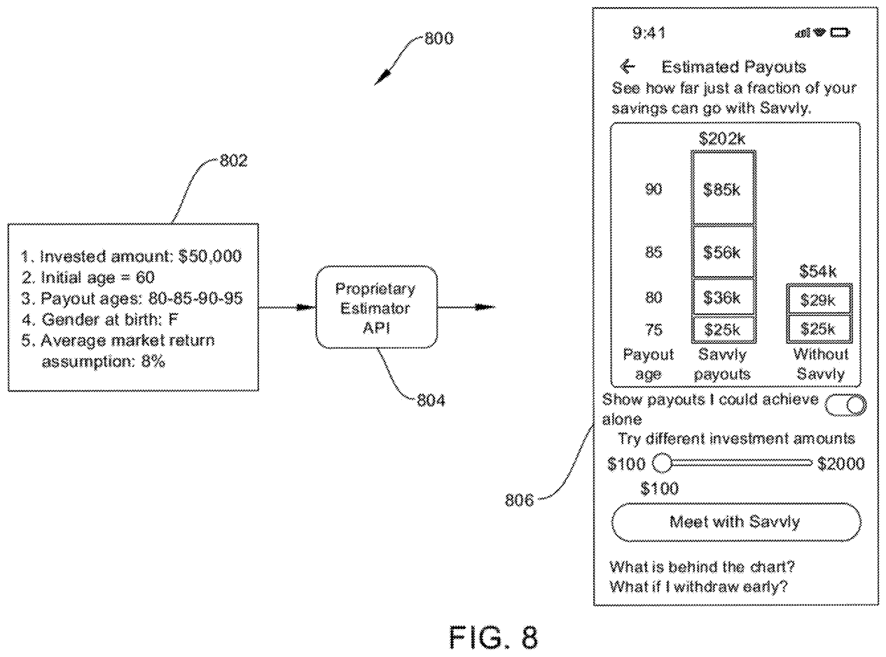

FIG. 8 depicts a non-limiting, exemplary embodiment of the system and method for incorporating a mortality risk in a financial instrument in use 800. In the embodiment depicted in FIG. 8, in step client/pool member information, investment information and market assumptions can be provided and passed to estimator module 646 of the mortality risk financial system and method 640. The estimator module 646 can then utilize the plurality of investment coefficient tables 714, generated as described in FIGS. 7A and 7B, to determine and present output results 804 based, at least in part, on the provided client/pool member information and plurality of investment coefficient tables 714. In some embodiments, alternate comparative performance estimates from other financial vehicles can be provided.

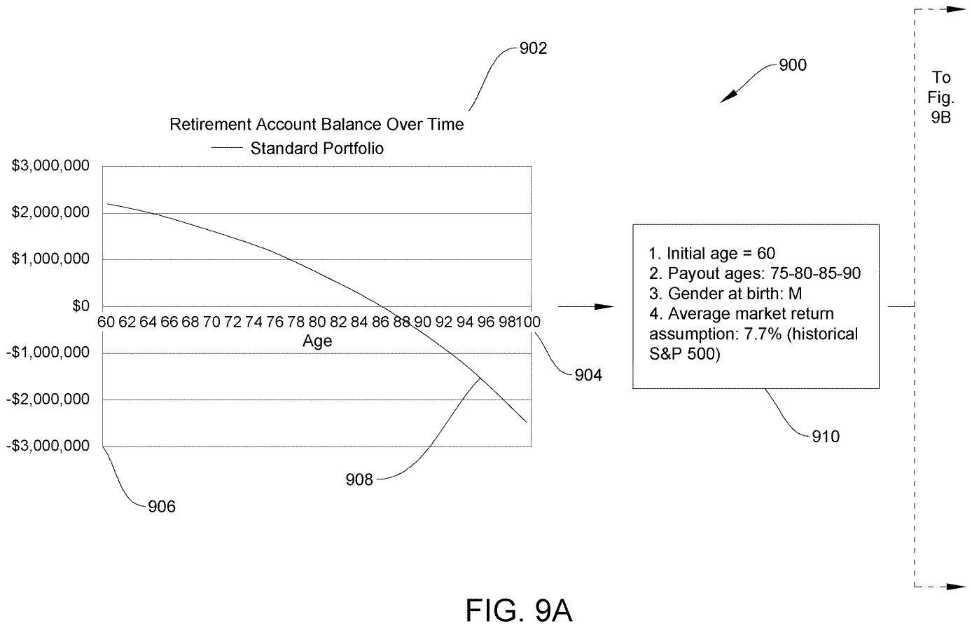

FIG. 9A and FIG. 9B depict a non-limiting, exemplary embodiment of a comparative outcome and output of the system and method for incorporating a mortality risk in a financial instrument 900. In the embodiment depicted in FIGS. 9A and 9B, the comparative outcome and output of the system and method for incorporating a mortality risk in a financial instrument 900 depicts a graphical representation of a standard, declining-balance, annuity over time 902 and a graphical representation of an enhanced-durability, declining-balance, annuity over time 906 utilizing the system and method described in FIGS. 6, 7A and 7B based on assumptions provided.

The graphical representation of a standard, declining-balance, annuity over time 902 comprises an x-axis representing age 908 of the client/pool member, a y-axis of account balance 910 and a declining balance of an account over time 912 anticipated based on standard portfolio performance. The graphical representation of an enhanced-durability, declining-balance, annuity over time 906 comprises the same axes and the shows the same standard declining balance of an account over time 912 as depicted by element 902 and additionally comprises a graphical representation of an enhanced-durability, declining-balance, annuity over time 914 based on the assumptions 906 provided and the additions to the to the client/pool member's portfolio resulting from participation in the system and method for incorporating a mortality risk in a financial instrument interface with external systems 600. In some embodiments, the assumptions 906 can comprise an initial age of the client/pool member, payout ages for the client/pool member, gender of the client/pool member, an anticipated market return value and/or any other known, convenient and/or desired data.

FIG. 10 depicts a schematic function block diagram of an implementation of the instantiation of a new client/pool member into the system method for incorporating a mortality risk in a financial instrument 1000. In the embodiment depicted in FIG. 10, in step 1002 input information is received from a client/pool member. As previously noted, such input information can comprise any known, convenient and/or desired client information such as, but not limited to, identifying information, contact information, age, gender, race, residence, occupation, socio-economic status, smoking information, health information and/or any other known, convenient and/or desired information. In step 1004, an account can be established and the client/pool member information can be validated in step 1006 via any known, convenient and/or desired, internal or external verification system and/or method.

In step 1008 a review of the agreed upon purchase terms and assumptions can be presented for the client/pool member to review before proceeding to step 1010 in which purchase contracts can be generated based, at least in part, on information collected in step 1002 and a client/pool member can be provided with required, discretionary and/or recommended disclosure documentation and subsequently execute any required, discretionary and/or recommended documents as to establish a relationship between the parties.

In step 1012, a purchase order can be initiated and the client/pool member's funds can be transferred in support of the purchase. Additionally, in step 1014 a client/pool member account can be established to enable client/pool member viewing or transactions, as authorized. In step 1016 the activities of steps 1010, 1012 and/or 1014 can be logged to a blockchain log for audit, authentication and/or any other known, convenient and/or desired purpose(s).

FIG. 11 depicts a schematic function block diagram of an implementation of the system and method for incorporating a mortality risk in a financial instrument 1100. In the embodiment depicted in FIG. 11, step 654 can perform a life status check using any known, convenient and/or desired internal or external system, as described in relation to FIG. 6. In step 1102 the system can receive an early withdrawal request from a client/pool member or client/pool member's estate. In step 1106, client/pool member's remaining balances can be determined and funds can be distributed to estates. In step 1108, the total pool gains can be reallocated based, at least in part, on prior pool gains and payouts from step 1106. In step 1110, gains to individual client/pool member accounts can be determined and individual client/pool member accounts can be updated with apportioned gains in step 1112. Then in step 652, individual client/pool member account details and balances and/or gains can be updates on the blockchain.

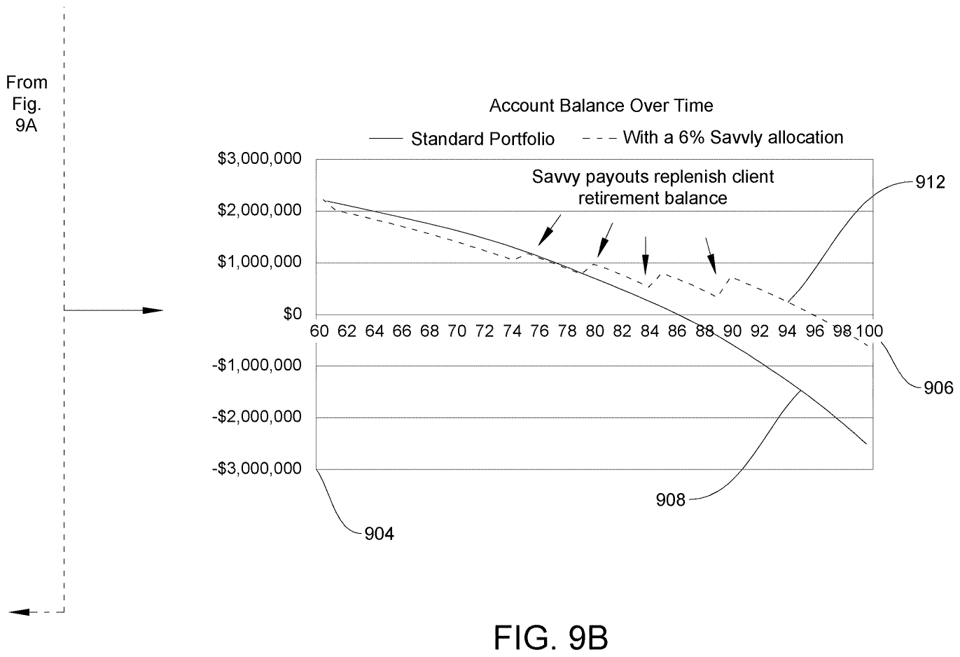

FIG. 12 depicts a method of updating 1200 the system and method for incorporating a mortality risk in a financial instrument interface with external systems 600. In step 1202, the system and method can receive an update regarding funds, such as from a new client/pool member or disbursement of funds to a client/pool member's estate associated with a change in the total pool member information 1204. The information from steps 1202 and 1204 can be combined to generate adjusted pool information in step 1206 with new/updated pool member information 1204 and updated pool member funds 1202. In some embodiments automated electronic processing of investment-product data can be performed using customized and/or specialized secure data architecture(s).

In step 1208 updated client/pool member funds allocations can be generated and recorded and then in step 1210 actuarial data regarding current client/pool members can be obtained and the aggregate pool information can be updated in step 1214. In some embodiments, actual performance data can be used with actuarial data 1212 to periodically and/or based on event trigger(s) update the pool information in step 1214.

Additionally, in step 1216 actual performance data and updated pool information and predictions 1210 can be combined in step 1218 to update total gains/modifications to the pool assets. Individual client/pool member accounts can be proportionally updated in step 1220 and such updates related to total pool gains/modification and individual client/pool member account data can be updated on the blockchain in step 1222. In step 1224, an event can trigger a new distribution which can trigger a funds change 1202 and a change in pool participants 1204 and result in reprocessing of the method of updating 1200 the system and method for incorporating a mortality risk in a financial instrument interface with external systems 600. In some alternate embodiments, the step of distribution 1224 can be initiated from the step of updating allocations within the pool and determining payouts in step 1208.

In some embodiments, the systems and method described herein can function with non-insurance-based products. For purposes of this description, an insurance-based product is a financial contract (a policy) sold by an insurer that provides financial protection against specific risks, like accidents, illness, or property damage, by agreeing to pay out a sum of money if a covered loss occurs in exchange for regular payments (premiums). These products offer a financial safety net, covering various aspects of life, health, business, or property, and can include health, auto, life, or commercial coverage, often being legally required or a condition of other contracts and a non-insurance-based product can be one or more products other than an insurance-based product.

FIG. 13 depicts a computing system adapted and configured to implement the system and method for incorporating a mortality risk in a financial instrument. The execution of the sequences of instructions required to practice the embodiments can be performed by a computer system 1300 as shown in FIG. 13. In an embodiment, execution of the sequences of instructions is performed by a single computer system 1300. According to other embodiments, two or more computer systems 1300 coupled by a communication link 1315 can perform the sequence of instructions in coordination with one another. Although a description of only one computer system 1300 will be presented below, however, it should be understood that any number of computer systems 1300 can be employed to practice the embodiments.

A computer system 1300 according to an embodiment will now be described with reference to FIG. 13, which is a block diagram of the functional components of a computer system 1300. As used herein, the term computer system 1300 is broadly used to describe any computing device that can store and independently run one or more programs.

Each computer system 1300 can include a communication interface 1314 coupled to the bus 1306. The communication interface 1314 provides two-way communication between computer systems 1300. The communication interface 1314 of a respective computer system 1300 transmits and receives electrical, electromagnetic or optical signals, that include data streams representing various types of signal information, e.g., instructions, messages and data. A communication link 1315 links one computer system 1300 with another computer system 1300. For example, the communication link 1315 can be a LAN, in which case the communication interface 1314 can be a LAN card, or the communication link 1315 can be a PSTN, in which case the communication interface 1314 can be an integrated services digital network (ISDN) card or a modem, or the communication link 1315 can be the Internet, in which case the communication interface 1314 can be a dial-up, cable or wireless modem.

A computer system 1300 can transmit and receive messages, data, and instructions, including program, i.e., application, code, through its respective communication link 1315 and communication interface 1314. Received program code can be executed by the respective processor(s) 1307 as it is received, and/or stored in the storage device 1310, or other associated non-volatile media, for later execution.

In an embodiment, the computer system 1300 operates in conjunction with a data storage system 1331, e.g., a data storage system 1331 that contains a database 1332 that is readily accessible by the computer system 1300. The computer system 1300 communicates with the data storage system 1331 through a data interface 1333. A data interface 1333, which is coupled to the bus 1306, transmits and receives electrical, electromagnetic or optical signals, that include data streams representing various types of signal information, e.g., instructions, messages and data. In embodiments, the functions of the data interface 1333 can be performed by the communication interface 1314.

Computer system 1300 includes a bus 1306 or other communication mechanism for communicating instructions, messages and data, collectively, information, and one or more processors 1307 coupled with the bus 1306 for processing information. Computer system 1300 also includes a main memory 1308, such as a random access memory (RAM) or other dynamic storage device, coupled to the bus 1306 for storing dynamic data and instructions to be executed by the processor(s) 1307. The main memory 1308 also can be used for storing temporary data, i.e., variables, or other intermediate information during execution of instructions by the processor(s) 1307.

The computer system 1300 can further include a read only memory (ROM) 1309 or other static storage device coupled to the bus 1306 for storing static data and instructions for the processor(s) 1307. A storage device 1310, such as a magnetic disk or optical disk, can also be provided and coupled to the bus 1306 for storing data and instructions for the processor(s) 1307.

A computer system 1300 can be coupled via the bus 1306 to a display device 1311, such as, but not limited to, a cathode ray tube (CRT) or a liquid-crystal display (LCD) monitor, for displaying information to a user. An input device 1312, e.g., alphanumeric and other keys, is coupled to the bus 1306 for communicating information and command selections to the processor(s) 1307.

According to one embodiment, an individual computer system 1300 performs specific operations by their respective processor(s) 1307 executing one or more sequences of one or more instructions contained in the main memory 1308. Such instructions can be read into the main memory 1308 from another computer-usable medium, such as the ROM 1309 or the storage device 1310. Execution of the sequences of instructions contained in the main memory 1308 causes the processor(s) 1307 to perform the processes described herein. In alternative embodiments, hard-wired circuitry can be used in place of or in combination with software instructions. Thus, embodiments are not limited to any specific combination of hardware circuitry and/or software.

The term “computer-usable medium,” as used herein, refers to any medium that provides information or is usable by the processor(s) 1307. Such a medium can take many forms, including, but not limited to, non-volatile, volatile and transmission media. Non-volatile media, i.e., media that can retain information in the absence of power, includes the ROM 1309, CD ROM, magnetic tape, and magnetic discs. Volatile media, i.e., media that can not retain information in the absence of power, includes the main memory 1308. Transmission media includes coaxial cables, copper wire and fiber optics, including the wires that comprise the bus 1306. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes can be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention can be implemented in a variety of computer systems. The various techniques described herein can be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high-level procedural or object oriented programming language to communicate with a computer system. However, the programs can be implemented in assembly or machine language, if desired. In any case, the language can be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system can also be considered to be implemented as a computer-readable storage medium, configured with a computer program, where the storage medium so configured causes a computer to operate in a specific and predefined manner. Further, the storage elements of the exemplary computing applications can be relational or sequential (flat file) type computing databases that are capable of storing data in various combinations and configurations.

A memory or storage device may be an example of a non-transitory computer-readable storage medium for use by or in connection with the video encoder and/or decoder. The non-transitory computer-readable storage medium contains instructions for controlling a computer system to be configured to perform functions described by particular embodiments. The instructions, when executed by one or more computer processors, may be configured to perform that which is described in particular embodiments.

Also, it is noted that some embodiments have been described as a process which can be depicted as a flow diagram or block diagram. Although each may describe the operations as a sequential process, many of the operations can be performed in parallel or concurrently. In addition, the order of the operations may be rearranged. A process may have additional steps not included in the figures.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be configured to perform that which is described in particular embodiments As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

Although exemplary embodiments of the invention have been described in detail and in language specific to structural features and/or methodological acts above, it is to be understood that those skilled in the art will readily appreciate that many additional modifications are possible in the exemplary embodiments without materially departing from the novel teachings and advantages of the invention. Moreover, it is to be understood that the subject matter defined in the appended claims is not necessarily limited to the specific features or acts described above. Accordingly, these and all such modifications are intended to be included within the scope of this invention construed in breadth and scope in accordance with the appended claims.

What is claimed is:

1. A computer system comprising:
at least one processor, at least one memory device and a network interface, the system configured for automated electronic processing of investment product data using a specialized secure data architecture for a constituency of investment pool members wherein each member has an investment transaction product that is in part dependent upon other member's investment transaction products, comprising:
receiving, in memory of a data processing system, initial user inputs, for defining an investment transaction product for a user in the constituency of pool members, comprising at least:
a) an initial funding amount; and
b) at least one user payout age;
generating and instantiating in said memory, a machine readable investment product record stored as a secure, encrypted data object having a system generated, non human readable identifier and maintained within a structured, tamper evident data repository electronic documentation associated with the user investment transaction product including security for the user investment transaction, wherein said documentation is stored in a secure, encrypted format using an identifier and is accessible via an interface;
monitoring a plurality of external databases for an indication of death for any of said pool members, the monitoring comprising automated event detection using pattern matching logic or machine assisted correlation;
automatically determining occurrence of a death for one or more pool members prior to their prescribed user payout age based at least in part on said step of monitoring said plurality of external databases, wherein the determining step includes filtering, validating, and cross correlating external data via a trained computational model configured to reduce false positives;
in response to said step of automatically determining occurrence of a death of one or more pool members prior to an associated prescribed user payout age, automatically reallocating at least a portion of said deceased pool member's funds, determined to have deceased prior to their prescribed user payout age, to investment funds associated with other pool members, if said deceased pool member died prior to said at least one prescribed user payout age, wherein said reallocation is performed using a programmed rules based engine implemented in code stored in the memory, said rules based engine configured to apply actuarial weighting and risk distribution parameters, using age, longevity factor, and investment value data of said investment transaction product for each pool member relative to the amounts invented and ages of all pool members stored in the secure data object structure;
automatically initiating a payout distribution to a pool member upon the occurrence of a pool member reaching their prescribed user payout age, wherein the payout includes funds associated with:
a) a value obtained from investment of the pool member's initial funding amount; and
b) a value obtained from funds reallocated to the pool member from other pool members determined to have deceased prior to their prescribed user payout age;
wherein said payout distribution is executed via an authenticated, encrypted transaction protocol in electronic communication with at least one external financial system.

2. The computer system as recited in claim 1, wherein the data processing system is cloud based.

3. The computer system as recited in claim 1, wherein the data processing system includes an Application Program Interface (API) configured for integration with at least one of the Internet and a mobile device software application that provides data communication with at least one of a portfolio management and financial planning computer software tool.

4. The computer system as recited in claim 1, wherein the initial user input further comprises information associated with an investment strategy for the initial funding amount.

5. The computer system as recited in claim 1, wherein the initial user input further comprises a user's current age and gender identification.

6. The computer system as recited in claim 1, wherein formulating the electronic documentation comprises creating a uniquely identifiable encryption hash indicator for the electronic documentation.

7. The computer system as recited in claim 1, wherein determining the occurrence of a death for one or more pool members comprises use of artificial intelligence to evaluate said plurality of external databases.

8. The computer system as recited in claim 1, wherein a payout distribution for a member comprises a longevity credit accumulated over time that is added to the member's market returns associated with the member's initial funding amount that cumulates reallocations from other pool members until the member's prescribed user payout age.

9. The computer system as recited in claim 1, wherein the data processing system is further configured to track, in real time, market value of common investments of pool members and the reallocated pool members funds.

10. The computer system as recited in claim 1, wherein the data processing system performs the reallocation of a pool member's assets to other pool members utilizing a combination of actuarial weighting and risk distribution parameters, said reallocation of said pool member's assets utilizes age, a longevity factor and the value of said investment transaction product of each said pool member relative to the amounts invested and ages of all pool members.

11. The computer system as recited in claim 1, wherein reallocating at least a portion of a pool member's funds further includes distribution of a portion of the pool member's funds, determined to have deceased prior to their prescribed payout age, to prescribed heirs associated with the deceased pool member.

12. The computer system as recited in claim 1, wherein the data processing system further includes a simulation tool configured and operable to estimate total investment returns at a poll member's payout age, wherein the simulation tool comprises a dedicated API configured for use by a sales front end application.

13. The computer system as recited in claim 12, wherein the simulation tool is further configured to automatically provide scheduled updates on the estimated total investment returns based upon financial market performance and reallocation of pool members funds.

14. The computer system as recited in claim 1, wherein the data processing system is further configured and operable to enable a pool member to liquidate their accumulated investment funds prior to their prescribed user payout age wherein a portion of the pool member's funds are distributed to a liquidating pool member and another portion of the liquidating pool member's funds are reallocated to investment funds associated with other pool members.

15. The computer system as recited in claim 1, wherein the data processing system is further configured and operable to enable a pool member to extend their prescribed user payout age.

16. The computer system as recited in claim 1, wherein the payout distribution is provided as prescribed by the user.

17. The computer system as recited in claim 1, wherein the payout distribution is provided in multiple payments spread apart via prescribed time periods, wherein each succeeding payout distribution accumulates at least one of: a) a value obtained from investment of the pool member's initial and any subsequent funding amounts; and b) a value obtained from funds reallocated to the pool member from other pool members determined to have deceased prior to their prescribed user payout age.

18. The computer system as recited in claim 17, wherein each succeeding time spaced multiple payment is dependent upon a succeeding user prescribed payout age.

19. The computer system as recited in claim 1, wherein reallocating at least a portion of a pool member's funds, determined to have deceased prior to their prescribed user payout age, depends, at least in part, on ages and investment funds associated with the other pool members.

20. The computer system as recited in claim 1, wherein the data processing system is further configured and operable to enable a pool member to transfer their accumulated investment funds to one or more external accounts prior to their prescribed user payout age whereby a portion of the pool member's funds are reallocated to investment funds associated with other pool members upon transfer of the investment funds to the one or more external accounts.
